(19) United States
(12) Patent Application Publication
(10) Pub. No.: US 2006/0156839 A1
(43) Pub. Date: Jul. 20, 2006

(54) Speed reduction gear of electric power steering device

(76) Inventors: Seiji Ueno, Maebashi-shi (JP); Kazuo Chikaraishi, Maebashi-shi (JP)

Correspondence Address: SIDLEY AUSTIN LLP, 717 NORTH HARWOOD, SUITE 3400, DALLAS, TX, 75201, US

(21) Appl. No.: 10/543,597

(22) PCT Filed: Sep. 30, 2004
(86) PCT No.: PCT/JP04/14800

§ 371 Date: Jul. 27, 2005

(30) Foreign Application Priority Data
Jan. 10, 2003 (JP) 2003-342774

(51) Int. Cl. F16H 35/00

(52) U.S. Cl. 74/388 PS

(57) ABSTRACT

An electric power steering device having a speed reduction gear using a toothed belt and capable of preventing the speed reduction gear from being locked and steering from being disabled even if the toothed belt is broken. A clearance Δ between the inner surface (21x) of the second housing (21b) of the speed reduction gear (40) and the rear surface (29a) of the toothed belt (29) applied to a toothed pulley (27) is formed larger than the tooth depth (H) of the toothed belt (29) (Δ>II). Thus, even if the toothed belt (29) is broken, the toothed belt (29) is not caught between the inner surface (21x) of the second housing (21b) and the outer peripheral surface (27a) of the second toothed pulley (27), and the toothed pulley (29) is not locked.

### TECHNICAL FIELD

This invention relates to an electric power steering device and particularly to the electric power steering device including a speed reduction gear using a toothed belt.

### BACKGROUND ART

In an electric power steering device adapted to generate auxiliary torque by an electric motor, the magnitude of steering torque generated on a steering shaft is detected, and the electric motor is driven by a control device for controlling a motor current depending on the detected steering torque to supply the auxiliary torque to the steering shaft.

The device is, for example, so constructed that a pinion connected to the steering shaft meshes with a rack shaft supported to displace in the axial direction, thereby converting the rotation of the steering shaft to the axial movement of the rack shaft to operate the direction of a steered wheel through a wheel steering mechanism, and in the mechanism, a ball screw mechanism is disposed between the electric motor and the rack shaft.

The ball screw mechanism is composed of a helical groove formed on the outer peripheral surface of the rack shaft, a nut member fitted to the outer periphery of the helical groove and provided with a helical groove formed on the inner peripheral surface, and a number of balls disposed between the two helical grooves. The electric motor is coupled to the nut member through a speed reduction gear, wherein the rotation of the electric motor rotates the nut member of the ball screw mechanism through the speed reduction gear to thereby move the rack shaft in the axial direction, thereby turning the steered wheel through the wheel steering mechanism.

In this type of electric power steering device, when the rack shaft is displaced from the neutral position in the axial direction by the operation of the steering wheel, the axial load and the load in the shearing direction (in the radial direction) are transmitted to the rack shaft so that bending moment is generated in the rack shaft by the load in the shearing direction to affect the ball screw mechanism.

That is, since the ball screw mechanism has very low acceptable capacity to the load in the shearing direction and high acceptable capacity to the axial load, when the bending moment is applied to the rack shaft to be deformed, the pitch of the helical groove formed on the rack shaft changes, and when the meshing accuracy of the rack shaft and the pinion is low, the rack shaft is vibrated in the radial direction with the rotation of the pinion. This results in that when excessive load is applied to the balls of the ball screw mechanism to disable the balls from smoothly rotating, the transmission efficiency of turning torque from the electric motor is lowered, and also the durability is lowered to inhibit the improvement in steering feeling.

As a measure against this, the constitution has been proposed in Japanese Utility Model Publication (B) No. H6-49489 (49489/1994), in which a toothed pulley is coaxially disposed on a rack shaft provided with a helical groove of a ball screw mechanism, the toothed pulley is coupled to a nut of the above ball screw mechanism to be integrally rotated and be displaced in the radial direction, and on the other hand, another toothed pulley is mounted on an electric motor, and a toothed belt is wrapped between the toothed pulley coaxially disposed on the rack shaft and the toothed pulley mounted on the electric motor to thereby transmit the turning force of the electric motor through a speed reducing mechanism and the ball screw mechanism to the rack shaft.

In the above constitution, excessive load is not applied to the ball screw mechanism so that the ball screw mechanism is smoothly rotated not to lower the transmission efficiency of turning torque from the electric motor and also the disadvantages such as lowering of durability and inhibition of the improvement in steering feeling can be nearly overcome.

On the other hand, in the electric power steering device including this type of speed reduction gear using the toothed belt, it is expected that a long-time use or application of excessive load will cause breakage of the toothed belt. When the toothed belt is broken, the turning force of the electric motor is not transmitted to the rack shaft to enter the manual steering state. Even in this case, steering for emergency refuge can be performed, so it has been considered that the steering mechanism is probably provided with a failsafe function.

However, when the broken toothed belt slips out of the toothed pulley to be caught in a space up to a housing, the speed reduction gear is locked. Especially, when the broken toothed belt is caught between the toothed pulley on the driven side, that is, on the rack shaft side and the housing so that the toothed pulley on the driven side is locked, the steering shaft is locked and disabled from steering to cause a very dangerous condition where the failsafe function of the steering mechanism will not work because the toothed pulley on the driven side and the rack shaft interlock with each other through the ball screw mechanism.

The invention has been made to solve the above problems and provide an electric power steering device including a speed reduction gear using a toothed belt, in which the speed reduction gear is so constructed that at least a clearance gap Δ between the inner peripheral surface of a housing of a driven side rotary member opposite to the toothed belt and the back face side of the toothed belt wrapped round a toothed pulley is larger than the tooth depth H of the toothed belt (Δ>H), whereby even if the toothed belt is broken, the toothed belt is not gripped between the inside surface of the housing and the outer peripheral surface of the toothed pulley to lock the toothed belt and there is no fear of causing disability of steering.

### DISCLOSURE OF THE INVENTION

According to the invention, an electric power steering device adapted to supply steering assisting force from a motor to a steering mechanism includes a speed reduction gear in which a toothed belt is stretched between a drive side rotary member mounted on a motor shaft and a driven side rotary member mounted on a steering mechanism, and the speed reduction gear is provided with a housing in which at least the clearance gap between the inner peripheral surface of a housing part for storing the driven side rotary member opposite to the toothed belt and the back face side of the toothed belt is set equal to or larger than the tooth depth of the toothed belt.

Further, according to the invention, an electric power steering device adapted to supply steering assisting force from a motor to a steering mechanism includes a drive side toothed pulley mounted on a motor shaft, a driven side toothed pulley mounted on a rotary member on the steering mechanism side, and a speed reduction gear formed of a toothed belt stretched between both toothed pulleys, and the speed reduction gear includes a housing in which at least the clearance gap between the inner peripheral surface opposite to the toothed belt wrapped round the driven side toothed pulley and the back face side of the toothed belt wrapped round the toothed pulley is set equal to or larger than the tooth depth of the toothed belt.

### BRIEF DESCRIPTION OF DRAWINGS

FIG. 1 is a cross section for explaining the constitution of the principal part of a rack shaft assembly provided with a belt speed reduction gear in an electric power steering device.

FIG. 2 is a front section for explaining the principal part of the conventional speed reduction gear using a toothed belt.

FIG. 3 is a front section for explaining the condition where the toothed belt is broken in the conventional speed reduction gear using the toothed belt shown in FIG. 2.

FIG. 4 is a front section for explaining a speed reduction gear using a toothed belt according to an embodiment of the invention.

FIG. 5 is a front section for explaining the condition where the toothed belt is broken in the speed reduction gear using the toothed belt according to the embodiment shown in FIG. 4.

FIG. 6 is a diagram for explaining the relationship between the clearance gap Δ between the inside surface of a housing A and the outer peripheral surface of a toothed pulley B and the tooth depth H of a toothed belt C.

FIG. 7 is a diagram for explaining the condition where the clearance gap Δ between the inside surface of the housing A and the outer peripheral surface of the toothed pulley B is set smaller than the tooth depth H of the toothed belt C (Δ<H) and the toothed belt C is caught there.

FIG. 8 is a diagram for explaining the constitution in which the clearance gap Δ between the inside surface of the housing A and the outer peripheral surface of the toothed pulley B is set larger than the tooth depth H of the toothed belt C (Δ>H).

### DESCRIPTION OF THE PREFERRED EMBODIMENTS

An embodiment of the invention will now be described.

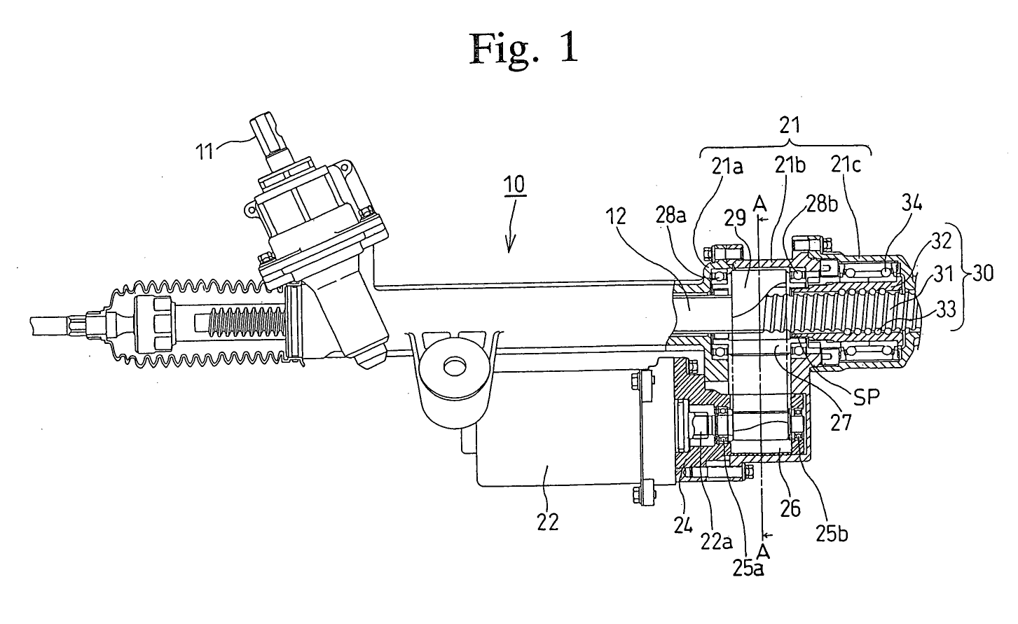

FIG. 1 is a cross section for explaining the constitution of the principal part of a rack shaft assembly 10 including a belt speed reduction gear of an electric power steering device according to an embodiment of the invention.

In FIG. 1, the reference numeral 11 is a steering shaft, 12 is a rack shaft, a pinion not shown, which is mounted at the end part of the steering shaft 11, and the rack shaft 12 mesh with each other to transmit the rotation of the steering shaft 11 to the rack shaft 12.

A rack shaft housing 21 is composed of a first housing 21a on which a motor flange 24 is mounted, a second housing 21b storing first and second toothed pulleys mentioned later, and a third housing 21c storing a ball screw mechanism also mentioned later.

A motor 22 includes a stator and a rotor in the interior not shown, a rotating shaft 22a extended from the rotor is rotatably supported by bearings 25a and 25b disposed in the motor flange 24, and a first toothed pulley 26 is fitted to the rotating shaft 22a.

A second toothed pulley 27, which is a driven side pulley, is cylindrical, the rack shaft 12 is passed through the interior thereof, and the second toothed pulley 27 is rotatably supported at both end parts in the axial direction of the cylinder by a bearing 28a disposed in the first housing 21a and a bearing 28b disposed in the second housing 21b.

A spline groove is formed on the inner peripheral surface of the second toothed pulley 27, and the spline groove and a spline projection formed on a nut 32 of the ball screw mechanism mentioned later are spline-coupled SP to be movable in the axial direction and relatively unrotatable in the rotating direction.

The ball screw mechanism 30 is composed of a helical groove 31 formed on the rack shaft 12, the nut 32 and a number of balls 33 disposed between the helical groove 31 and the nut 32, and the nut 32 is rotatably held by a bearing 34 disposed in the third housing 21c.

The assembling procedure of the rack shaft assembly including the above belt speed reduction gear will be described simply. The bearings 25a and 25b are disposed in the motor housing 24, the first toothed pulley 26 is fitted to the motor rotating shaft 22a supported by the bearings 25a and 25b, and in this state, the motor housing 24 is mounted on the first housing 21a. The bearing 28a is disposed in the first housing 21a, thereby rotatably supporting the second toothed pulley 27, and a toothed belt 29 is wrapped between the first toothed pulley 26 and the second toothed pulley 27.

The second housing 21b where the bearing 28a is mounted is mounted on the first housing 21a, and the other end of the second toothed pulley 27 supported by the bearing 28a is rotatably supported by the bearing 28b.

Further, the third housing 21c where the ball screw mechanism 30 is assembled is fitted to the second housing 21b, the rack shaft 12 is passed through the second toothed pulley 27, and the spline groove of the inside surface of the second toothed pulley 27 and the spline projection of the nut 32 of the ball screw mechanism 30 are spline-coupled SP to complete the rack shaft assembly 10 including a belt speed reduction gear.

In the above rack shaft assembly 10, the first toothed pulley 26, the second toothed pulley 27 and the toothed belt 29 constitute a belt speed reduction gear 40.

On the basis of the steering torque of the steering shaft detected by a torque sensor not shown, the driving turning force of the motor 22 driven by a control device also not shown is transmitted through the first toothed pulley 26, the toothed belt 29 and the second toothed pulley 27 to the nut 32 of the ball screw mechanism 30. By the rotation of the nut 32, the rack shaft 12 is moved in the axial direction to turn the wheels so that steering is performed.

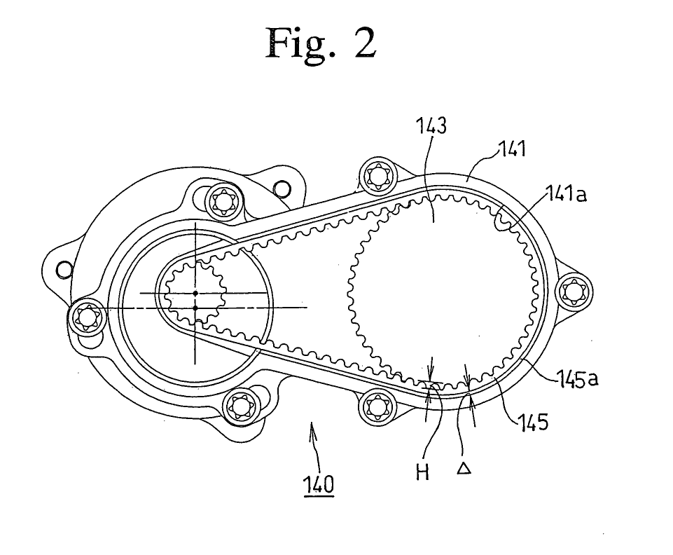

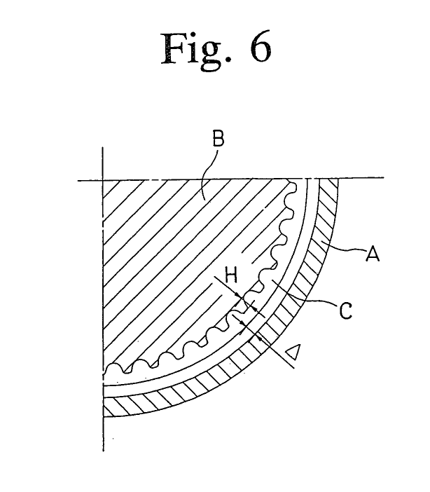

The relationship between the toothed belt and the housing will now be described. FIG. 2 is a front view showing the constitution of a speed reduction gear 140 using the conventional toothed belt, in which although the relationship between the clearance gap Δ between an inside surface 141a of a housing 141 of the speed reduction gear 140 and a back face side 145a of a toothed belt 145 wrapped round a toothed pulley 143 and the tooth depth H of the toothed belt 145 will be described later with reference to FIG. 6, the above clearance gap Δ is set smaller than the tooth depth H of the toothed belt 145 (Δ<H).

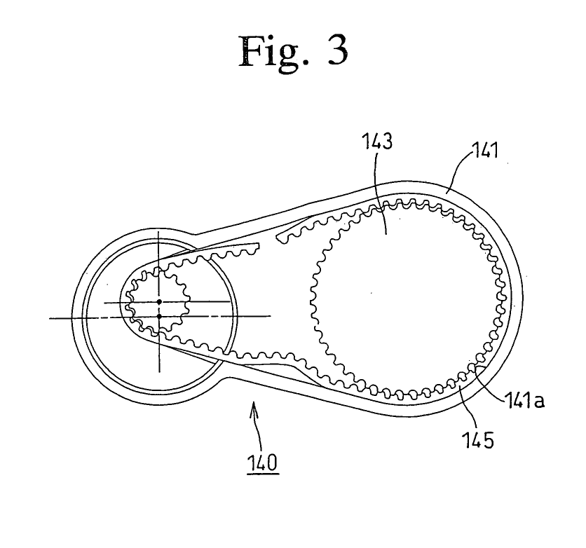

Consequently, when the toothed belt 145 is broken, as shown in FIG. 3, the toothed belt 145 is gripped between the inside surface 141a of the housing 141 and the outer peripheral surface of the toothed pulley 143 so that the toothed pulley 143 is locked.

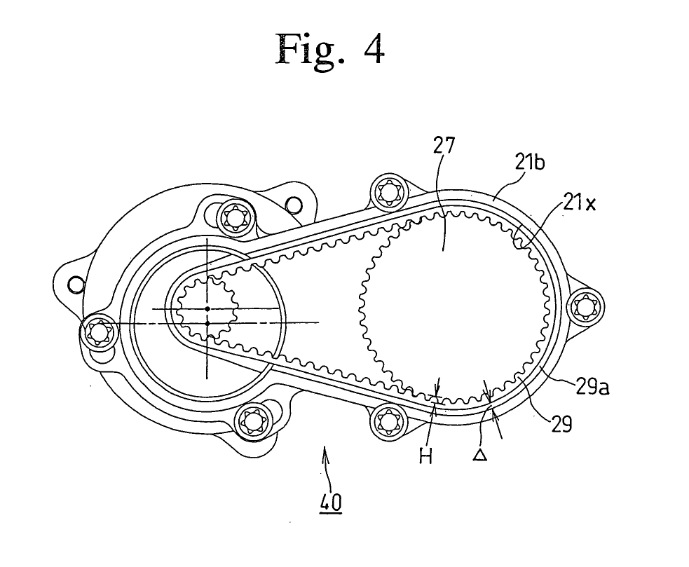

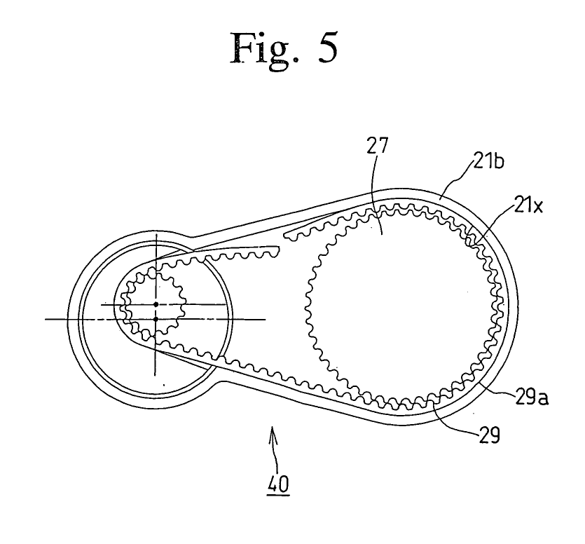

FIG. 4 is a front section showing the constitution of the speed reduction gear 40 part, which shows a section taken along a line A-A of FIG. 1. The clearance gap Δ between the inside surface 21X of the second housing 21b of the speed reduction gear 40 and the back face 29a of the toothed belt 29 wrapped round the toothed pulley 27 is larger than the tooth depth H of the toothed belt 29 (Δ>H). Accordingly, when the toothed belt 29 is broken, as shown in FIG. 5, the toothed belt 29 is not gripped between the inside surface 21X of the second housing 21b and the outer peripheral surface of the second toothed pulley 27 to prevent the toothed pulley 27 from being locked.

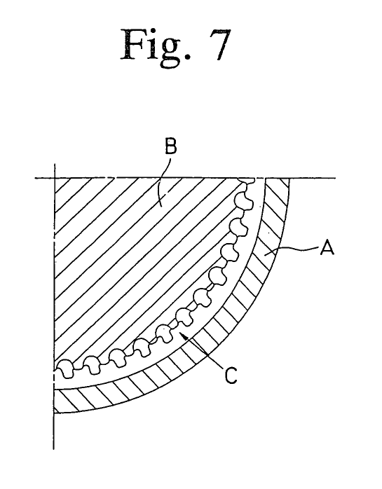

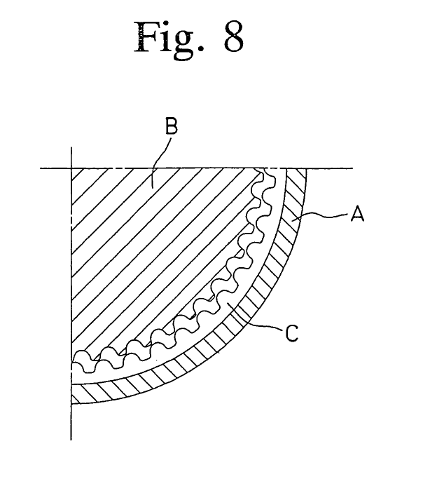

FIGS. 6 to 8 are diagrams for explaining the relationship between the clearance gap Δ between the inside surface of the housing A and the back face of the toothed belt C wrapped round the toothed pulley B and the tooth depth H of the toothed belt C, and the gripping of the toothed belt C, FIG. 6 is a diagram for explaining the relationship between the clearance gap Δ between the inside surface of the housing A and the back face of the toothed belt C wrapped round the toothed pulley B and the tooth depth H of the toothed belt C, FIG. 7 shows the condition where the clearance gap Δ is smaller than the tooth depth H (Δ<H) and the toothed belt C is gripped there, and FIG. 8 shows the condition where the clearance gap Δ is larger than the tooth depth H (Δ>H) so that the toothed belt C is not gripped.

In the case where the clearance gap Δ is smaller than the tooth depth H (Δ<H), as shown in FIG. 7, the toothed belt C is gripped between the inside surface of the housing A and the outer peripheral surface of the toothed pulley B so that the toothed pulley B is locked. On the other hand, in the case where the clearance gap Δ is larger than the tooth depth H (Δ>H), as shown in FIG. 8, the toothed belt C is not gripped between the inside surface of the housing A and the outer peripheral surface of the toothed pulley B so that the toothed pulley B is not locked.

### INDUSTRIAL APPLICABILITY

This invention may provide an electric power steering device including the speed reduction gear using the toothed belt, in which since the speed reduction gear is so constructed that at least the clearance gap Δ between the inner peripheral surface of the driven side rotary member opposite to the toothed belt of the housing and the back face side of the toothed belt wrapped round the toothed pulley is larger than the tooth depth H of the toothed belt (Δ>H), even if the toothed belt is broken, the toothed belt is not gripped between the inside surface of the housing and the outer peripheral surface of the toothed pulley so that the toothed pulley is not locked, and there is no fear of disabling steering.

What is claimed is:

1. A speed reduction gear of an electric power steering device adapted to supply steering assisting force from a motor to a steering mechanism, comprising:
a speed reduction gear in which a toothed belt is wrapped between a drive side rotary member mounted on a motor shaft and a driven side rotary member mounted on a steering mechanism,
characterized in that the speed reduction gear includes a housing in which at least the clearance gap between the inner peripheral surface of a housing part for storing the driven side rotary member opposite to the toothed belt and the back face side of the toothed belt is set equal to or larger than the tooth depth of the toothed belt.

2. A speed reduction gear of an electric power steering device, comprising: a speed reduction gear including a drive side toothed pulley mounted on a motor shaft; a driven side toothed pulley mounted on a rotary member on the steering mechanism side; and a toothed belt wrapped between both toothed pulleys,
characterized in that the speed reduction gear includes a housing in which at least the clearance gap between the inner peripheral surface opposite to the toothed belt wrapped round the driven side toothed pulley and the back face side of the toothed belt wrapped round the toothed pulley is set equal to or larger than the tooth depth of the toothed belt.
